(19) United States
(12) Patent Application Publication
(10) Pub. No.: US 2005/0282698 A1
(43) Pub. Date: Dec. 22, 2005

(54) Particulate filter device and exhaust treatment system, and methods of regenerating the same

(76) Inventors: Barry W. Southward, Catoosa, OK (US); John G. Nunan, Tulsa, OK (US)

Correspondence Address: Paul L. Marshall;Delphi Technologies, Inc., M/C 480-410-202, P.O. Box 5052, Troy, MI, 48007, US

(21) Appl. No.: 10/873,279

(22) Filed: Jun. 22, 2004

(51) Int. Cl. B01J 20/34

(52) U.S. Cl. 502/34; 422/177

(57) ABSTRACT

A particulate filter device comprises a particulate filter comprising a substrate having a redox active material disposed thereon, wherein the redox active material is a solid solution capable of transformation between a stable reduced form and a stable oxidized form, and is capable of generating an exotherm under re-oxidizing conditions; and a housing disposed around the substrate.

### BACKGROUND

In order to meet exhaust gas emission standards, the exhaust emitted from internal combustion engines is treated prior to emission into the atmosphere. Exhaust is passed through a catalytic element to remove undesirable gaseous emission components such as unburned hydrocarbons, carbon monoxide, and nitrogen oxides. In addition to the gaseous components, exhaust gases also contain particulate matter such as carbon-containing particles or soot. A catalyzed particulate filter, a device gaining increasing application with compression ignition engines, is used to prevent soot, or carbonaceous particulates from exiting the tailpipe. Carbonaceous particulates are stored in the filter and then burned so that the filter is regenerated and able to again store the carbonaceous particulates.

Regeneration of particulate filters can be accomplished by the use of auxiliary devices such as a burner or other heating element. For example, an air-fuel nozzle and an ignition device can be used and operated, when desired, to heat the exhaust gases and the particulate filter to a combustion temperature of the trapped particulate matter. In this manner, the trapped particulate matter can be burned from the filter surfaces to permit a continuous flow of the exhaust gases. Alternatively, an electric heater can be used to generate the heat to initiate the combustion of the trapped particulates. In addition, the filter may also be regenerated by a so-called “active” cycle in which secondary fuel injection is combusted using an oxidation catalyst to generate an exotherm within the filter and hence initiate regeneration.

These methods of regeneration, as well as other traditional regeneration methods, are energy intensive. Accordingly, what is needed in the art is an improved particulate filter and methods of regenerating the filter that offers a reduction in energy demands during regeneration compared to traditional particulate filters and traditional methods of regenerating the particulate filter.

### SUMMARY

One embodiment of a particulate filter device comprises a particulate filter comprising a substrate having a redox active material disposed thereon, wherein the redox active material is a solid solution capable of transformation between a stable reduced form and a stable oxidized form, and is capable of generating an exotherm under re-oxidizing conditions; and a housing disposed around the substrate.

One embodiment of a method of regenerating a particulate filter device comprises passing a gas through a particulate filter; reducing an oxidation state of a redox active material; re-oxidizing the redox active material to generate an exotherm; and combusting soot in the particulate filter at a regeneration temperature.

One embodiment of an exhaust treatment system, comprises a particulate filter comprising a substrate having a redox active material disposed thereon, wherein the redox active material is a solid solution capable of transformation between a stable reduced form and a stable oxidized form, and is capable of generating an exotherm under re-oxidizing conditions; and a housing disposed around the substrate; and a NO_{X} adsorber in fluid communication with the particulate filter.

One embodiment of a method of regenerating an exhaust treatment system comprises introducing a reducing agent into an exhaust stream; reducing NO_{X} stored in a NO_{X} adsorber; reducing an oxidation state of a redox active material in a particulate filter, wherein the redox active material is a solid solution; re-oxidizing the oxidation of state of the redox active material to generate an exotherm; and combusting soot in the particulate filter at a regeneration temperature.

The above-described and other features will be appreciated and understood by those skilled in the art from the following detailed description, drawings, and appended claims.

### BRIEF DESCRIPTION OF THE DRAWINGS

Refer now to the figures, which are exemplary embodiments, and wherein the like elements are numbered alike.

FIG. 1 is a partial cross-sectional view of a particulate filter.

FIG. 2 is a prospective view of an embodiment of a particulate filter substrate comprising a blocked alternate cell honeycombed structure.

FIG. 3 is a graphical representation of the redox activity characteristics and retention capacity for Ce—Zr based solid solutions doped with various reducible base metals such as Fe, Cu, and Ni.

FIG. 4 is a graphical representation of the redox activity characteristics and retention capacity for Ce—Zr based solid solutions doped with Cu.

FIG. 5 is a graphical representation of the passive regeneration characteristics for Ce—Zr based solid solutions compared to a “comparative catalyst” that is a platinum/cerium oxide catalyst composition.

FIG. 6 is a bar graph summarizing the passive regeneration activities of the Ce—Zr based solid solutions and the comparative catalyst illustrated in FIG. 5.

FIG. 7 is a comparison of “balance-point” measurements of a Ce—Zr based solid solution technology (OSC C illustrated in FIGS. 5 and 6) compared to the comparative catalyst illustrated in FIGS. 5 and 6.

### DETAILED DESCRIPTION

Disclosed herein is a particulate filter comprising an active redox (e.g., oxidization-reduction) material that is capable of transformation between a stable reduced form and a stable oxidized form, and is capable of generating an exotherm under re-oxidizing conditions. As will be discussed in greater detail below, heat generated by redox reactions occurring within the particulate filter may be used to regenerate the particulate filter. The term “redox reactions” is used broadly throughout this disclosure to include those reactions associated with oxidation/reduction of various metal oxides and/or composite oxides, as well as other chemical transformations, such as sulfation/de-sulfation, nitration/de-nitration, hydroxylation/dehydroxylations, oxide-sulfate inter-conversions, and the like, which have significant enthalpy change in a reaction (ΔHs of reaction), e.g., 387.3 kilojoules per mole (kJ/mol) for the re-oxidation of Ce III to Ce IV.

It should further be noted that the terms “first,” “second,” and the like herein do not denote any order or importance, but rather are used to distinguish one element from another, and the terms “a” and “an” herein do not denote a limitation of quantity, but rather denote the presence of at least one of the referenced items. Furthermore, all ranges disclosed herein are inclusive and combinable (e.g., ranges of “up to about 25 weight percent (wt. %), with about 5 wt. % to about 20 wt. % desired, and about 10 wt. % to about 15 wt. % more desired,” is inclusive of the endpoints and all intermediate values of the ranges, e.g., “about 5 wt. % to about 25 wt. %, about 5 wt. % to about 15 wt. %”, etc.).

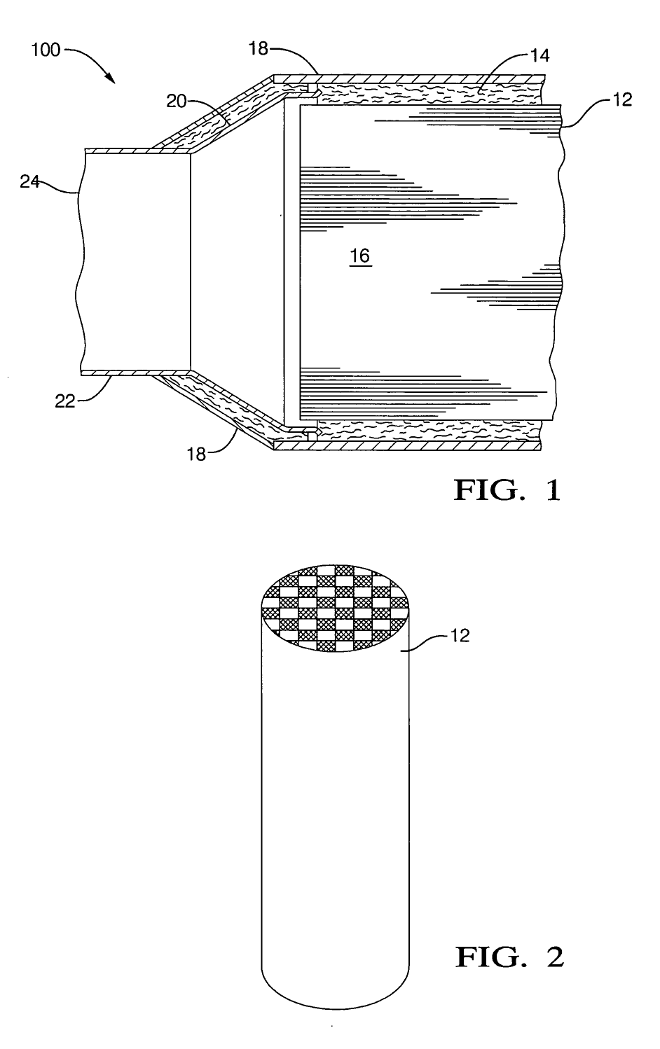

Referring now to FIG. 1, an exemplary embodiment of a particulate filter/trap generally designated 100 is illustrated. Preferably, the particulate filter 100 is capable of being used in a diesel exhaust system. The particulate filter 100 comprises a substrate 12 disposed within a retention material 14 forming a subassembly 16. A housing 18 is disposed around the subassembly 16. An end-cone 20 comprising a snorkel 22 having an opening 24 is in physical communication with housing 18. Opening 24 allows exhaust fluid communication with substrate 12.

Although the substrate 12 may have any size or geometry, the size and geometry are preferably chosen to optimize surface area in the particulate filter 100. For example, the substrate 12 may have a honeycomb geometry, with the combs through-channel having any multi-sided or rounded shape, with substantially square, triangular, pentagonal, hexagonal, heptagonal, or octagonal or similar geometries preferred due to ease of manufacturing and increased surface area.

In an embodiment, particulate filter 100 can be a wall flow type filter comprising a honeycombed, material for the substrate 12. Exemplary materials for the substrate are listed below. For example, the wall flow type filter can comprise silicon carbide. Referring now to FIG. 2, alternate cells of the honeycombed structure are preferably plugged such that exhaust gas enters in one cell, is forced through the porous walls of the cell, and then exits the structure through another cell. It is noted that the size of the diesel particulate filter 100 depends upon the particular application.

Substrate 12 may comprise any material designed for use in a diesel engine environment and having the following characteristics: (1) capable of operating at temperatures up to about 1000° C., with temperatures of about 100° C. to about 600° C. typical; (2) capable of withstanding exposure to hydrocarbons, nitrogen oxides, carbon monoxide, particulate matter (e.g., soot and the like), carbon dioxide, and/or gaseous compounds of sulfur such as SO₂, COS, and H₂S; and (3) having sufficient surface area and structural integrity to support a catalyst and/or redox active material. Some possible substrate materials include cordierite, silicon carbide, metal, metal oxides (e.g., alumina, and the like), glasses, and the like, and mixtures comprising at least one of the foregoing materials. Some ceramic materials include “Honey Ceram”, commercially available from NGK-Locke, Inc, Southfield, Mich., and “Celcor”, commercially available from Corning, Inc., Corning, N.Y. These materials may be in the form of foils, perform, mat, fibrous material, monoliths (e.g., a honeycomb structure, and the like), other porous structures (e.g., porous glasses, sponges), foams, pellets, particles, molecular sieves, and the like, and combinations comprising at least one of the foregoing materials and forms, e.g., metallic foils, open pore alumina sponges, and porous ultra-low expansion glasses.

Located between the substrate 12 and the housing 18 may be a retention material 14 that insulates the housing 18 from both the exhaust fluid temperatures. The retention material 14, which enhances the structural integrity of the substrate by applying compressive radial forces about it, reducing its axial movement and retaining it in place, may be concentrically disposed around the substrate to form a retention material/substrate subassembly 16.

The retention material 14, which may be in the form of a mat, particulates, or the like, may be an intumescent material (e.g., a material that comprises vermiculite component, i.e., a component that expands upon the application of heat), a non-intumescent material, or a combination thereof. These materials may comprise ceramic materials (e.g., ceramic fibers) and other materials such as organic and inorganic binders and the like, or combinations comprising at least one of the foregoing materials. Non-intumescent materials include materials such as those sold under the trademarks “NEXTEL” and “INTERAM 1101HT” by the “3M” Company, Minneapolis, Minn., or those sold under the trademark, “FIBERFRAX” and “CC-MAX” by the Unifrax Co., Niagara Falls, N.Y., and the like. Intumescent materials include materials sold under the trademark “INTERAM” by the “3M” Company, Minneapolis, Minn., as well as those intumescents which are also sold under the aforementioned “FIBERFRAX” trademark, as well as combinations thereof and others.

The retention material/substrate subassembly 16 may be concentrically disposed within a housing 18. The choice of material for the housing 18 depends upon the type of exhaust fluid, the maximum temperature reached by the substrate 12, the maximum temperature of the exhaust fluid stream, and the like. Suitable materials for the housing 18 may comprise any material that is capable of resisting under-car salt, temperature, and corrosion. For example, ferrous materials may be employed such as ferritic stainless steels. Ferritic stainless steels may include stainless steels such as, e.g., the 400-Series such as SS-409, SS-439, and SS-441, with grade SS-409 generally preferred.

As briefly mentioned above, the particulate filter (e.g., 100) comprises a substrate (e.g., 12) having a redox (oxidation-reduction) active material disposed thereon, wherein the redox active material is capable of transformation between a stable reduced form and a stable oxidized form. More particularly, the redox active material is preferably a solid solution. It is noted that the form of the redox active material (e.g., reduced or oxidized) depends upon local prevailing conditions that occur in a diesel exhaust stream, i.e., the redox material may be oxidized under fuel lean (excess oxygen) conditions (e.g., an air to fuel ratio greater than or equal to 19) or reduced under locally fuel rich conditions (e.g. during a transient or forced fuel-initiated regeneration cycle, e.g., an air to fuel ratio less than 19). Without being bound by theory, the redox active material facilitates regeneration of the particulate filter 100 by virtue of the fundamental energetics of the redox reaction(s). More particularly, an exotherm is generated under re-oxidizing conditions, which can increase the rate of any local combustion reaction. Furthermore, it is noted that the redox material provides active “labile” oxygen to the soot and/or active organic material trapped in the particulate filter 100, which ensures that full and efficient oxidation occurs and that oxygen depletion or mass transfer does not inhibit the extent or rate of conversion of the soot and/or active organic material.

The redox reactive material is of a type and is present in an amount sufficient to facilitate the regeneration of the particulate filter under relatively “cool” temperatures compared to the higher temperatures associated with traditional methods of regeneration. For example, the particulate filter disclosed herein is capable of being regenerated at temperatures less than or equal to about 400° C., with a regeneration temperature less than or equal to about 250° C. achievable. More particularly, a regeneration temperature of about 250° C. to about 400° C. may be obtained, with a regeneration temperature of about 300° C. to about 400° C. readily obtained. In comparison, regeneration temperatures of greater than or equal to about 550° C. are employed for traditional filter designs and traditional regeneration methods.

Further, it is noted that the redox active material may generate an exotherm under re-oxidation conditions even without the use of a platinum group metal (PGM) catalysts (e.g., platinum, palladium, rhodium, ruthenium, iridium, and osmium). It is noted that PGM catalysts are expensive. Therefore, any reduction in the PGM loading or elimination of the use of a PGM in the particulate filter may offer a large reduction in the cost of the exhaust treatment device (e.g., the particulate filter). As such, the particulate filter can operate effectively in the absence of a PGM. It should be noted, however, that PGMs may be used in various embodiments. For example, PGM may be employed in embodiments were the particulate filter comprises a NO_{X} adsorber function. For example, the PGM can be employed at about 0.1 wt. % to about 4.0 wt. %, with 0.5 wt. % to about 3 wt. % preferred, and about 1 wt. % to about 2 wt. % more preferred. In other embodiments, the particulate filter may comprise PGMs to further improve the regeneration ability of the particulate filter. Preferably, the PGM is platinum and/or palladium.

The redox active material and/or PGM catalyst may be disposed on/throughout the substrate (hereinafter “on”). The redox active material and/or PGM may be applied to the substrate 12 by any suitable deposition method. For example, redox active material can be washcoated, imbibed, impregnated, physisorbed, chemisorbed, precipitated, sprayed, or otherwise applied to the substrate 12. In an embodiment, the redox active material is homogeneously applied on the substrate, i.e., a concentration gradient of less than or equal to 10 wt. %, wherein the weight percent is based on the total weight of the redox active material, is observed over the substrate. In other embodiments, the redox active material may be “zone coated” on the substrate such that the concentration of the redox active material can differ at various locations (zones) within the substrate.

In an embodiment, the redox active material preferably is an oxygen storage (OS) material. These OS materials can include, but are not limited to, metal oxides and composite metal oxides that are capable of transformation between a stable reduced form and a stable oxidized form. Suitable oxides and composite oxides include cerium oxide, composite oxides of cerium oxide with rare earth or alkaline earth oxides; composite oxides of cerium oxide with transition metal oxides such as zirconium, iron, cobalt, nickel, manganese; and oxides of manganese and iron and composite oxides of manganese and iron with other suitable oxides. The OS material may include a combination comprising at least one of the foregoing oxides.

In those embodiments where the OS material comprises cerium oxide and/or the composite oxides of cerium with rare earths, alkaline earths, and/or transition metals, preferably the OS material is a solid solution of the constituent metal oxides. Preferably, the solid solution is a single-phase solid solution having a cubic structure, with a cubic fluorite structure more preferred. In various embodiments, the OS material may include those OS materials disclosed in U.S. Pat. Nos. 6,585,944, 6,468,941, 6,387,338, and 6,605,264, which are herein incorporated by reference in their entirety. For example, an OS material preferably has a stable cubic structure in which redox active reducible base metals are incorporated into the crystal structure. It is noted that the reducible base metal oxides can serve a function similar to that of PGMs in that the reducible base metal oxides promote the reduction and re-oxidation of cerium within the solid solution. These base metals may reduce out of the structure under rich (reducing) conditions but can reenter the structure under lean (oxidizing) conditions. Preferably, the OS material comprises cerium (Ce), zirconium (Zr), a stabilizer (e.g., yttrium (Y), and optionally other rare earths (niobium (Nb), lanthanum (La), praseodymium (Pr), neodymium (Nd), terbium (Tb) and the like as set forth in the Periodic Table), and optionally a redox active base metal. The base metal can be iron (Fe), copper (Cu), cobalt (Co), nickel (Ni), silver (Ag), manganese (Mn), bismuth (Bi), and the like, as well as combinations comprising at least one of these base metals.

Preferably, the OS materials comprise a composition having a balance of a sufficient amount of zirconium to preferably minimize the reduction energies of Ce⁴⁺ and the activation energy for mobility of ‘O’ within the lattice, a sufficient amount of cerium to provide the desired oxygen storage capacity, sufficient amount of stabilizer (e.g., yttrium, rare earth (La+Pr) or yttrium/rare earth metal) to stabilize the solid solution in the cubic crystalline phase, and a sufficient amount of base metal (Fe, Cu, Co, Ni, Ag, Mn, Bi, and the like, as well as combinations comprising at least one of the foregoing) to enhance both the facile nature and the capacity of the oxygen storage function. However, it is noted that other embodiments may be base metal free, i.e., those embodiments do not comprise base metals (Fe, Cu, Co, Ni, Ag, Mn, Bi, and the like).

These OS materials are further characterized by having a single-phase cubic crystal structure, preferably a cubic fluorite crystal structure. The percentage of the OS material having the cubic structure is preferably greater than about 95%, with greater than about 99% typical, and essentially 100% cubic structure generally obtained (i.e., an immeasurable amount of tetragonal phase based on current measurement technology). The OS material is further characterized in that it possesses large improvements in durable redox activity with respect to facile oxygen storage and increased capacity. Thus, for Cu containing solid solutions, for example, the reduction of Ce+Cu is observed to occur at a temperature of about 300° C. to about 350° C. lower than would occur in the absence of the Cu dopant. In the case of iron, the Ce+Fe reduction is shifted to lower temperatures by about 50° C. to about 150° C.

In an exemplary embodiment, the OS material, based upon 100 mole % of the material preferably comprises up to about 95 mole % zirconium; up to about 50 mole % cerium; up to about 20 mole % of a stabilizer selected from the group consisting of yttrium, rare earths, alkaline earths, and combinations comprising at least one of the stabilizers; and about 0.01 to about 25 mole % of a base metal selected from the group consisting of iron, copper, cobalt, nickel, silver, manganese, bismuth and mixtures comprising at least one of the foregoing metals. In yet another embodiment, the OS material preferably has a formula within the range Zr_{(0.55-0.78)}Ce_{(0.16-0.40)}Y_{(0.05-0.075)}La_{(0.04-0.075)}O_{(1.875-1.975)}. Preferably, the OS material comprises about 20 mole % cerium to about 50 mole % cerium. Examples include (on a mole % basis), but are not limited to, Ce_{37.66}Zr_{49.37}Hf_{0.49}La_{8.59}Pr_{3.89}, Ce_{38.02}Zr_{49.85}Hf_{0.63}Nd_{8.40}Pr_{3.10}, Ce_{38.74}Zr_{50.79}Hf_{0.64}Pr_{9.84}, and Ce_{30.47}Zr_{51.71}Hf_{0.65}Pr_{17.17}.

In other embodiments, the OS material is preferably a solid solution of Ce—Zr—R—Nb, wherein Ce comprises less than or equal to about 40 mole % based on 100 mole % of the solid solution, and wherein “R” is a rare earth metal, alkaline earth metal or a combination comprising at least one of the foregoing metals, with yttrium, magnesium, calcium, strontium, lanthanum, praseodymium, neodymium, and combinations comprising at least one of these metals preferred, with yttrium and praseodymium especially preferred.

It is noted that the oxides of Nb are potentially redox active due to the existence of the three different valent states, i.e., Nb⁵⁺, Nb⁴⁺, and Nb³⁺ oxides:
Nb⁵⁺₂O₅⇄Nb⁴⁺O₂(Nb³⁺₂O₃)+O₂
However, Nb⁵⁺/Nb₄₊ and Nb⁵⁺/Nb³⁺ oxidation/reduction reactions are not facile and only occur at very high temperatures of about 1,200° C. to about 1,250° C. as compared to much lower temperatures for CeO₂ or Ce—Zr based solid solutions. However, when incorporated into the compositions, Nb itself becomes much more redox active and can be readily reduced to the Nb⁴⁺ and Nb³⁺ valent states when exposed to reducing gas mixtures. These lower valent states of Nb are not readily accessible under normal conditions but become so when Nb is incorporated into the crystal structures of the Ce,Zr,ROₓ compositions. Furthermore, mixtures of Nb with the individual oxides, sub-mixtures of oxides, or composite oxides of CeO₂, ZrO₂ and Y₂O₃ do not exhibit the much improved redox activity.

The OS material is preferably present in an amount sufficient to generate an exotherm under re-oxidizing conditions. For example, the OS material may be loaded on the substrate in amount of about 0.1 gram per cubic inch (g/in³) (about 0.006 gram per cubic centimeter (g/cm³) to about 4.0 g/in³ (about 0.2 g/cm³), with a loading of about 0.4 g/in³ (0.02 g/cm³) to about 2.0 g/in³ (about 1.2 g/cm³) preferred.

It has also been discovered that there can be a synergistic effect between the regeneration of a NO_{X} adsorber (also referred to as a “lean-NO_{X} trap”) and the regeneration of a particulate filter comprising a redox active material capable of generating an exotherm under re-oxidation conditions. The NO_{X} adsorber promotes the catalytic oxidation of NO_{X} by utilizing catalytic metal components effective for such oxidation, such as precious metals. The formation of NO₂ is generally followed by the formation of a nitrate when the NO₂ is adsorbed onto the catalyst surface. The NO₂ is thus “trapped”, i.e., stored, on the catalyst surface in the nitrate form. As will be discussed in greater detail, the system can be periodically operated under fuel-rich conditions to regenerate the NO_{X} adsorber.

Generally, a NO_{X} adsorber comprises a substrate, catalytic metal(s), support materials, and NO_{X} trapping material(s). The catalytic metal component, the catalytic metal support, and the NO_{X} trapping materials can be washcoated, imbibed, impregnated, physisorbed, chemisorbed, precipitated, or otherwise applied onto a substrate.

The substrate may include those designs and materials as described above with respect to particulate filter 100 illustrated in FIG. 1. For example, some possible substrate materials include cordierite, mullite, metallic foils, zirconium toughened aluminum oxide, silicon carbide and the like, and mixtures comprising at least one of the foregoing materials. Preferably, the NO_{X} adsorber substrate is a cordierite substrate with an extruded honeycomb cell geometry comprising less than or about 600 cells per square inch, and a wall thickness of less than or equal to about 4.0 mils (about 0.01 cm).

The catalytic metal(s) is preferably capable of being used as a NO_{X} reduction catalyst. For example, the catalyst may include, but is not limited to, platinum, palladium, rhodium, ruthenium, iridium, osmium, and combinations comprising at least one of the foregoing.

The support material of the NO_{X} adsorber can include, but is not limited to, zirconium oxides, gamma aluminum oxide, delta aluminum oxide, theta aluminum oxide, Lanthanum (La) or Barium (Ba) stabilized aluminum oxides, alkaline earth aluminates transition metal hexaaluminates and the like, as well as combinations comprising at least one of the foregoing, and more particularly solid solutions comprising zirconium.

In addition to the catalytic metal, the support materials may be further loaded with NO_{X} trapping material(s), such as alkali metal oxides, alkaline earth metal oxides, and mixtures comprising at least one of the foregoing metal oxides. Suitable trapping materials include oxides of barium, strontium, calcium, magnesium, cesium, lithium, sodium, potassium, magnesium, rubidium and the like, and combinations comprising at least one of the foregoing, and more particularly a mixture of oxides of barium and potassium.

The NO_{X} trapping material can be employed in an amount sufficient to adsorb NO_{X}, e.g., the NO_{X} trapping materials may be employed in an amount less than or equal to about 28 wt. % based on the combined total weight of the catalytic metal, support materials, and NO_{X} trapping material (“NO_{X} combined weight”), with about 4 wt. % to about 28 wt. % preferred, about 8 wt. % to about 22 wt. % more preferred, and about 12 wt. % to about 16 wt. % even more preferred. The catalytic metal can be employed at about 0.1 wt. % to about 4.0 wt. %, with 0.5 wt. % to about 3 wt. % preferred, and about 1 wt. % to about 2 wt. % more preferred.

In various embodiments, the particulate filter is in fluid communication with the NO_{X} adsorber, and may be located upstream of and/or downstream of the NO_{X} adsorber. Generally, a particulate filter is positioned upstream of a NO_{X} adsorber for “heavy duty” applications, e.g., over the highway tractors, trucks, and the like, and downstream of a NO_{X} adsorber for “light duty” applications e.g., passenger cars. In yet other embodiments, the NO_{X} adsorber and the particulate filter may be incorporated into a single exhaust treatment device. The exhaust treatment device may resemble the particulate filter embodiment illustrated in FIG. 1. Multiple substrates (bricks) may be disposed within a housing, wherein one brick may perform a NO_{X} adsorber function and another brick may perform a particulate filter function. Embodiments are also envisioned where a single substrate (monolith) acts as both a NO_{X} adsorber and a particulate filter.

As briefly mentioned above, the NO_{X} adsorber can be regenerated, for example, when the engine is operated under fuel-rich combustion. During this period of fuel-rich combustion, the decrease of oxygen content and the presence of reducing agents promote the reduction and subsequent release of the stored nitrates as nitrogen and water. During fuel-rich operation and/or introduction of a reductant (e.g., NH₃, H₂, hydrocarbons, and the like) into the exhaust stream, NO_{X} trapped on a NO_{X} adsorber may be reduced to innocuous nitrogen gas (N₂). Under these similar conditions, the redox active material (e.g., OS materials) of the particulate filter is reduced to lower oxidation states. More particularly, in systems comprising cerium (Ce), Ce⁴⁺ is reduced to Ce³⁺.

When the exhaust returns to usual lean conditions, the redox active material is re-oxidized, wherein an exotherm is generated sufficient to initiate and/or propagate regeneration of the particulate filter. Traditionally, a particulate filter is regenerated under more fuel rich conditions, i.e., in a more reducing environment. More particularly, the reducing agent (e.g., hydrocarbons, carbon monoxide, hydrogen) is reacted with oxygen to generate an exotherm sufficient to regenerate the particulate trap. Unlike those traditional methods, the methods disclosed herein actually generate an exotherm without the use of a PGM catalyst and with a significantly diminished fuel penalty, i.e., less fuel may be consumed to produce a reducing environment to separately regenerate a NO_{X} adsorber and a particulate filter.

In other words, a synergy between the regeneration of a NO_{X} adsorber and the regeneration of particulate filter is realized. While the NO_{X} adsorber is being regenerated, the particulate filter is in a sense being “primed” for regeneration, i.e., the oxidation state of the redox active material is reduced (e.g., Ce⁴⁺ is reduced to Ce³⁺). When regeneration of the NO_{X} adsorber is complete, the system returns to lean operating conditions as discussed above, wherein an exotherm is generated by the re-oxidation of the redox active material.

As noted above, in various embodiments, an exhaust treatment device can comprise both the function of a NO_{X} adsorber and function of a particulate filter. In this embodiment, the device preferably comprises a NO_{X} adsorbing material, an oxidation catalyst (e.g., a PGM), and a redox active material. It is noted that the redox active material may act as support material for the NO_{X} adsorbing material. However, unlike traditional support materials (e.g., alumina), the redox active material may generate an exotherm under re-oxidizing conditions as discussed above.

It should also be noted that a particulate filter may be regenerated without regenerating a NO_{X} adsorber and/or incorporation of NO_{X} adsorber material(s) in an exhaust treatment device as described above. In such an embodiment, the system may optionally be regenerated by traditional methods, i.e., by periodically introducing a reducing agent into the particulate filter. However, the temperatures of regeneration and concentration of reductant are decreased compared to traditional methods by the use of the redox active materials disclosed herein.

### EXAMPLES

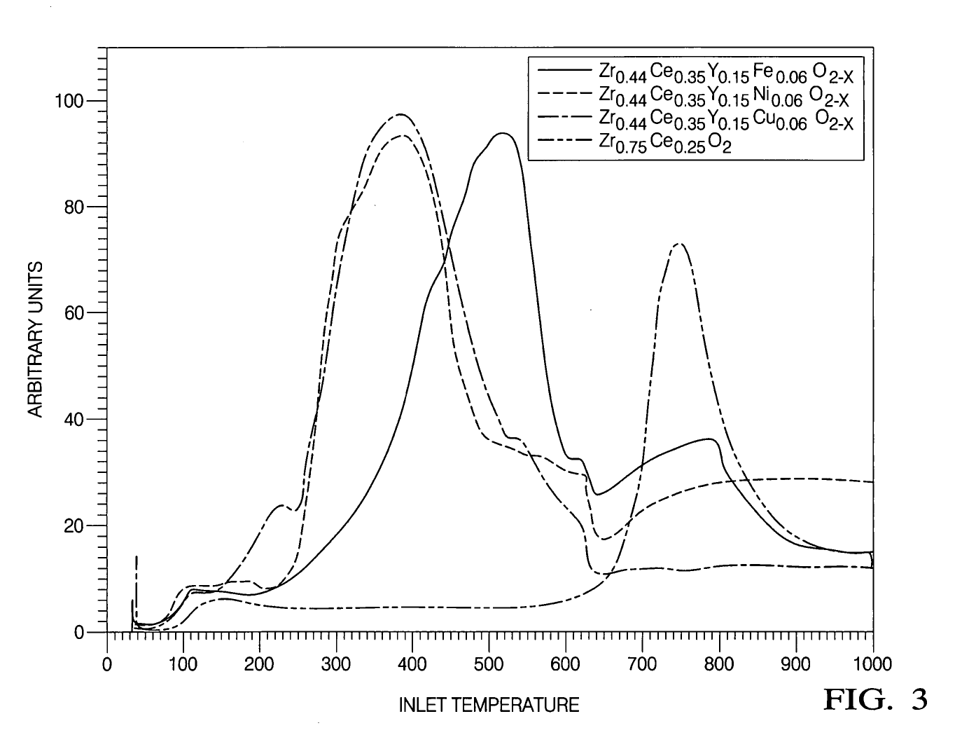

FIG. 3 is a graphical representation of the redox activity characteristics and retention capacity for Ce—Zr based solid solutions doped with various reducible base metals such as Fe, Cu, and Ni. The samples were aged at 1,150° C. for 36 hours in air. It is noted that the solid solutions including Fe, Cu, and Ni had enhanced redox activity compared to the sample that did not include these base metals.

The curves illustrated in FIG. 3 are an illustration of the rate of hydrogen (H₂) uptake as a function of temperature and an illustration of the variation of this rate with temperature. The peak (maximum) for each curve corresponds to the highest rate of H₂ uptake by the sample. The lower the temperature for the peak (highest rate) in H₂ uptake, the more facile (easy/reactive) the material is for reduction. Using an appropriate calibration graph of peak area versus H₂ uptake, the amount of H₂ uptake for a given sample or temperature range can be measured, thereby quantifying the redox activity of the material. For example, the solid solutions including Fe, Cu, and Ni all had lower peaks compared to the solid solution without Fe, Cu, and Ni. More particularly, the solid solutions comprising Ni and Cu had a peak of about 380° C. compared to about 750° C. for the solid solution without Fe, Cu, and Ni.

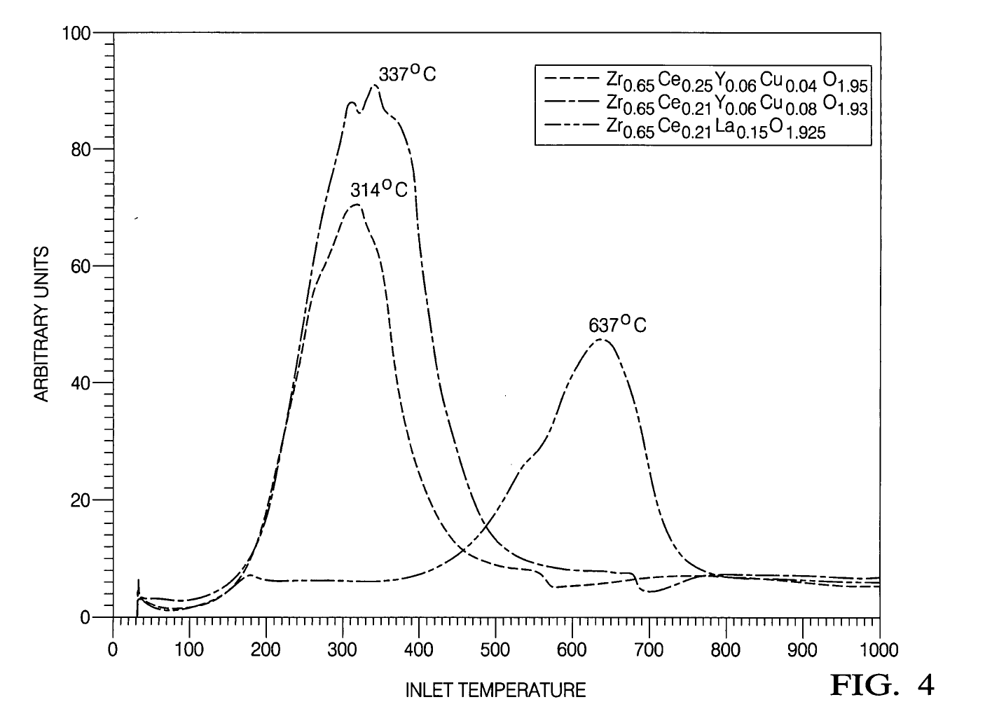

FIG. 4 is a graphical representation of the redox activity characteristics and retention capacity for Ce—Zr based solutions doped with Cu. The samples were aged as described above. It is noted that the samples had improved redox activity as illustrated by the lowering of the reduction temperature. Furthermore, it is noted that the sample comprising Zr_{0.65}Ce_{0.25}Y_{0.06}Cu_{0.04}O_{1.95} had a peak of 314° C., whereas the sample comprising Zr_{0.65}Ce_{0.21}Y_{0.06}Cu_{0.08}O_{1.93} had a peak of 337° C. Moreover, it is noted that each of these peaks were at a lower temperature compared to the sample comprising Zr_{0.65}Ce_{0.21}La_{0.15}O_{1.925}, which had a peak of 637° C.

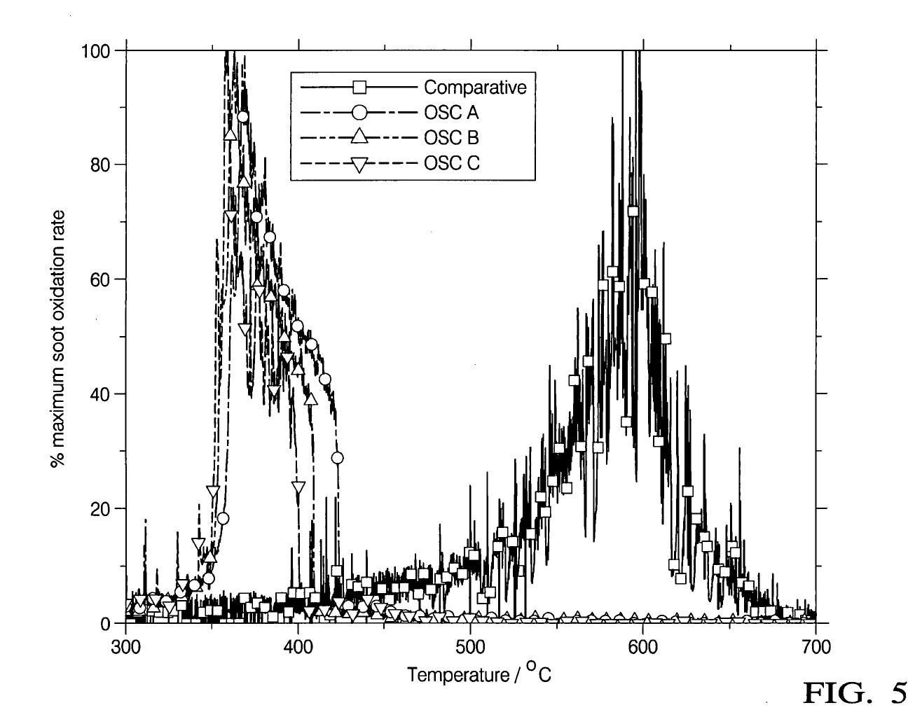

FIG. 5 is a graphical representation of the passive regeneration characteristics for Ce—Zr based solid solutions compared to a platinum/cerium oxide catalyst composition. The peaks in this graphical representation illustrate the temperatures at which a soot oxidation rate is maximized. In this example, a “comparative” catalyst, i.e., a platinum/cerium oxide catalyst composition was compared to three oxygen storage solid solution systems (OSC A, OSC B, and OSC C). The comparative catalyst used in this exampled comprises 4.72 wt. % Pt, 23.83 wt. % CeO₂, and 71.46% Al₂O₃, wherein weight percent is based on total weight of the catalyst. The OSC A catalyst comprises 31.50 wt. % CeO₂, 57.53 wt. % ZrO₂, 0.97 wt. % HfO₂, 5.00 wt. % La₂O₃, and 5.00 wt. % Y₂O₃, wherein weight percent is based on total weight of OSC A catalyst. The OSC B catalyst comprises 44.00 wt. % CeO₂, 45.23 wt. % ZrO₂, 0.77 wt. % HfO₂, 5.00 wt. % La₂O₃, and 5.00 wt. % Y₂O₃, wherein weight percent is based on total weight of OSC B catalyst. The OSC C catalyst comprises 44.00 wt. % CeO₂, 41.30 wt. % ZrO₂, 0.70 wt. % HfO₂, 9.50 wt. % La₂O₃, and 4.50 wt. % Pr₆O₁₁, wherein weight percent is based on total weight of OSC C catalyst.

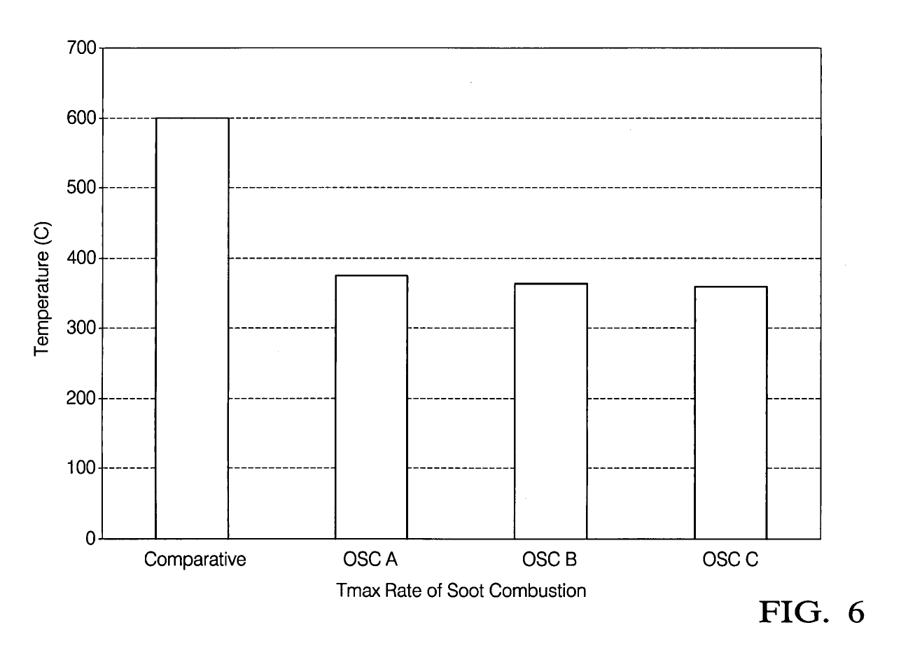

It is noted that the three oxygen storage systems had a peak temperature substantially less than the comparative catalyst. More particularly, the three oxygen storage systems had a peak temperature of about 350° C. to about 370° C. compared to a peak temperature of about 600° C. for the comparative catalyst. It is noted that these peak temperatures are better illustrated in FIG. 6, which is a bar graph summarizing the passive regeneration activities of the Ce—Zr based solid solutions and the platinum/cerium oxide catalyst composition illustrated in FIG. 5.

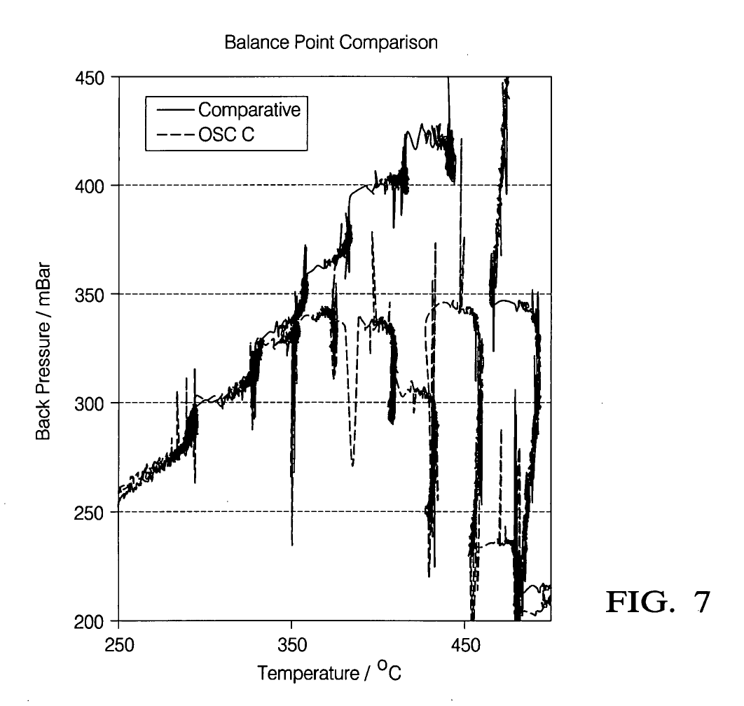

FIG. 7 is a comparison of “balance-point” measurements of a Ce—Zr based solid solution technology (OSC C catalyst illustrated in FIGS. 5 and 6) compared to a platinum/cerium oxide catalyst composition (“comparative” catalyst illustrated in FIGS. 5 and 6). This graph shows that the formulation comprising the OSC C catalyst has a balance point of soot deposition and soot composition occurs at 350° C. compared to about 450° C. It is noted that the “balance point” refers to the engine operating condition and the exhaust temperature where the soot combustion rate is greater or equal to the engine soot output.

Advantageously, disclosed herein are particulate filters/exhaust treatment devices and methods of their regeneration that employ less PGM (preferably less than 0.1 wt. % PGM, based upon a total weight of all catalyst materials employed in the particular filter, with no PGMs especially preferred) than traditional particulate filters. As such, a reduction in the cost of the particulate filter may be realized. Furthermore, the particulate filter may be regenerated at a reduced fuel penalty compared to a traditional particulate filter. These systems also operate differently than traditional systems, such that NO_{X} regeneration under fuel rich condition prepares the particulate filter for regeneration under fuel lean operating conditions. For example, when the NO_{X} adsorber is being regenerated, the oxidation state of the redox active material is reduced (e.g., Ce⁴⁺ is reduced to Ce³⁺). When regeneration of the NO_{X} adsorber is complete, the system returns to lean operating conditions, wherein an exotherm is generated by the re-oxidation of the redox active material sufficient to regenerate the particulate filter. Traditionally, an exotherm is generated using an oxidation catalyst in a fuel rich environment to oxidize, for example, hydrocarbons to generate the exotherm to regenerate the particulate filter.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A particulate filter device comprising:
a particulate filter comprising a substrate having a redox active material disposed thereon, wherein the redox active material is a solid solution capable of transformation between a stable reduced form and a stable oxidized form, and is capable of generating an exotherm under re-oxidizing conditions; and
a housing disposed around the substrate.

2. The particulate filter device of claim 1, wherein the particulate filter is a wall flow type filter.

3. The particulate filter device of claim 1, wherein the particulate filter is capable of being regenerated at a temperature less than or equal to about 400° C.

4. The particulate filter device of claim 3, wherein the temperature is about 250° C. to about 400° C.

5. The particulate filter device of claim 1, wherein the particulate filter does not comprise a platinum group metal.

6. The particulate filter device of claim 1, wherein the particulate filter comprises a platinum group metal.

7. The particulate filter device of claim 1, wherein the platinum group metal is selected from the group consisting of platinum, palladium, and combinations comprising at least one of the foregoing metals.

8. The particulate filter device of claim 1, further comprising a NO_{X} adsorbent material and an oxidation catalyst disposed on the substrate.

9. The particulate filter device of claim 1, wherein the redox active material is an oxygen storage material.

10. The particulate filter device of claim 9, wherein the oxygen storage material comprises cerium, zirconium, iron, cobalt, nickel, manganese, or a combination comprising at least one of the foregoing.

11. The particulate filter device of claim 10, wherein the oxygen storage material comprises up to about 95 mole % zirconium; about 30 mole % to about 50 mole % cerium; up to about 20 mole % of a stabilizer selected from the group consisting of yttrium, rare earths, alkaline earths and combinations comprising at least one of the stabilizers; and about 0.01 to about 25 mole % of a base metal selected from the group consisting of iron, copper, cobalt, nickel, silver, manganese, bismuth, and mixtures comprising at least one of the foregoing metals, wherein mole percents are based on 100 mole % of the oxygen storage material.

12. The particulate filter device of claim 10, wherein the oxygen storage material comprises about 50 mole % to about 85 mole % zirconium; about 10 mole % to about 30 mole % cerium; about 2 mole % to about 11 mole % R, about 2 to about 11 mole % niobium, wherein R is a rare earth or alkaline earth metal, of a combination comprising at least one of the foregoing metals.

13. The particulate filter device of claim 10, wherein the oxygen storage material comprises a cubic crystal structure.

14. The particulate filter device of claim 13, wherein the cubic crystal structure is a cubic fluorite crystal structure.

15. The particular filter device of claim 10, wherein the oxygen storage material is selected from the group consisting of Ce_{37.66}Zr_{49.37}Hf_{0.49}La_{8.59}Pr_{3.89}, Ce_{38.02}Zr_{49.85}Hf_{0.63}Nd_{8.40}Pr_{3.10}, Ce_{38.74}Zr_{50.79}Hf_{0.64}Pr_{9.84}, and Ce_{30.47}Zr_{51.71}Hf_{0.65}Pr_{17.17}.

16. The particulate filter device of claim 10, wherein the oxygen storage material is loaded on the substrate in amount of about 0.006 g/cm³ to about 0.2 g/cm³.

17. A method of regenerating a particulate filter device, the method comprising:
passing a gas through a particulate filter;
reducing an oxidation state of a redox active material;
re-oxidizing the redox active material to generate an exotherm; and
combusting soot in the particulate filter at a regeneration temperature.

18. The method of claim 17, further comprising trapping NO_{X} on a NO_{X} adsorbent material, introducing a reducing agent into the particulate filter; and reducing the trapped NO_{X}.

19. The method of claim 17, wherein the regeneration temperature is less than or equal to about 400° C.

20. The method of claim 19, wherein the regeneration temperature is less than or equal to about 250° C.

21. An exhaust treatment system, comprising:
a particulate filter device comprising a substrate having a redox active material disposed thereon, wherein the redox active material is a solid solution capable of transformation between a stable reduced form and a stable oxidized form, and is capable of generating an exotherm under re-oxidizing conditions; and a housing disposed around the substrate; and
a NO_{X} adsorber in fluid communication with the particulate filter device.

22. The exhaust treatment system of claim 21, wherein the NO_{X} adsorber is located upstream of the particulate filter device.

23. The exhaust treatment system of claim 21, wherein NO_{X} adsorber is located downstream of the particulate filter device.

24. A method of regenerating an exhaust treatment system, the method comprising:
introducing a reducing agent into an exhaust stream;
reducing NO_{X} stored in a NO_{X} adsorber;
reducing an oxidation state of a redox active material in a particulate filter, wherein the redox active material is a solid solution;
re-oxidizing the oxidation of state of the redox active material to generate an exotherm; and
combusting soot in the particulate filter at a regeneration temperature.

25. The method of claim 24, wherein the regeneration temperature is less than or equal to about 400° C.

26. The method of claim 25, wherein the regeneration temperature is less than or equal to about 250° C.
